(19) United States
(12) Patent Application Publication
(10) Pub. No.: US 2012/0077166 A1
(43) Pub. Date: Mar. 29, 2012

(54) PORTABLE BRUSHING STATION

(76) Inventor: Dwayne Cyr, Belleview, FL (US)

(21) Appl. No.: 12/891,884

(22) Filed: Sep. 28, 2010

(51) Int. Cl. G09B 23/28; A47K 1/04

(52) U.S. Cl. 434/262; 4/628; 4/643

(57) ABSTRACT

A portable brushing station for encouraging good brushing habits in children includes a cabinet assembly having a countertop and a concave sink with a portable water supply and removable drainage unit. Additionally, the portable brushing station can include a removable sink and drain combination which can be easily cleaned after each use. Additionally, the portable brushing station can include an instructional and entertainment unit for interactively teaching children proper brushing habits.

### BACKGROUND

1. Field of the Invention

The present invention relates generally to a portable children's bathroom apparatus, and more particularly to a portable brushing station for encouraging proper dental hygiene in children.

2. Description of the Related Art

One of the best ways to encourage proper dental hygiene is to train children at a young age to brush their teeth on a regular basis. However, as any parent will attest it is no easy task to stand a young child on a chair or stool in front of a bathroom sink while instructing them to brush their teeth. Additionally, from the child's perspective, the process can be intimidating and lacking in entertainment and stimulation, which discourages the child from fully participating.

Although there are a number of known portable wash basins available for use in a variety of circumstances, many of these are difficult for a child to operate and even more difficult for an adult to assemble, clean and maintain.

Accordingly, it would be beneficial to provide a portable brushing station that overcomes the issues described above while providing a fun and entertaining environment that encourages children to brush their teeth. It is also an objective of the invention to provide a portable brushing station that is simple to use, clean and maintain, and which is economical to manufacture.

### SUMMARY OF THE INVENTION

The present invention is directed to a portable brushing station for encouraging good brushing habits in children. One embodiment of the present invention can include

a cabinet assembly having a countertop and a concave sink with a portable water supply and removable drainage unit.

Another embodiment of the present invention can include a removable sink and drain combination which can be easily cleaned after each use.

Yet another embodiment of the present invention can include an instructional and entertainment unit for interactively teaching children proper brushing habits.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a portable brushing station that is useful for understanding the inventive concepts disclosed herein.

FIG. 2 is a front view of the portable brushing station according to one embodiment of the invention.

FIG. 3 is a perspective view of a portable brushing station according to another embodiment of the invention.

FIG. 4 is a side by side view of a portable brushing station according to another embodiment of the invention.

FIG. 5 is a perspective view of a portable brushing station according to another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

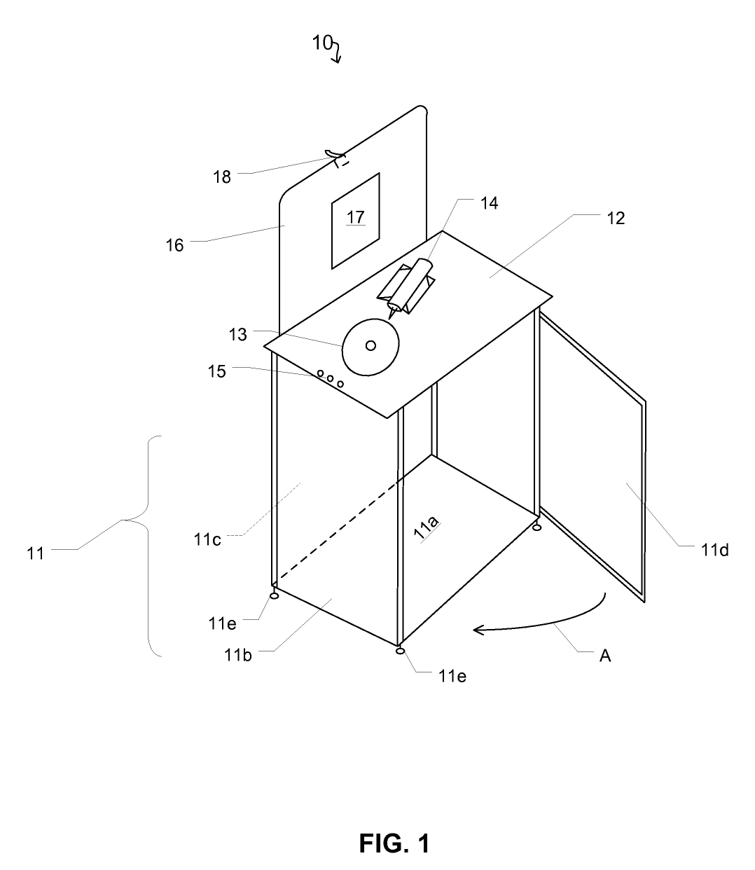

FIG. 1 illustrates one embodiment of a portable brushing station 10 that is useful for understanding the inventive concepts disclosed herein. As shown, FIG. 1 includes a lower cabinet area 11, a countertop 12 and a raised backsplash 16.

The lower cabinet area 11 can act to form the base of the apparatus and to provide storage for a variety of items. As such, the lower cabinet area can include a bottom wall 11a having side walls 11b, a back wall 11c and a front wall 11d extending upward therefrom to connect with a countertop 12 thus forming a cavernous interior space. Bottom wall 11a can further include adjustable telescoping legs 11e connected to each corner thereof in order to allow the height of the cabinet to be adjusted to fit the needs of a user.

In one preferred embodiment, front wall 11d can be attached to either side wall 11b via a hinge or other such device to create a door for providing access to the cavernous interior (see arrow A). Alternatively, front wall 11d can be securely affixed to both side walls 11b and can include a door (not shown) positioned at a center portion thereof for providing access to the interior of the cabinet.

The countertop 12 can be positioned parallel to the bottom wall 11a and can include a concave area forming a sink 13 extending downward into the cavernous interior. In one embodiment, a removable water bottle 14, having a fixed holder 14a can be positioned adjacent to the sink in order to provide a reusable clean water source that can be easily removed and cleaned. To this end, by orienting the water bottle 14 at a downward angle, water can flow from the bottle 14 from the effects of gravity, thus eliminating the need for a pump which can be difficult for a child to operate. Additionally, the countertop 13 can further include toothbrush holders 15 for positioning a plurality of brushing utensils. Although described above as including a water bottle, one of skill in the art will recognize that virtually any type of portable container capable of storing and discharging water can be utilized.

The raised backsplash 16 can include a reflective surface 17 (such as a child safety minor, for example), and an optional securing unit 18 configured to secure the apparatus to a fixed surface such as a wall or cabinet in order to prevent the brushing station from becoming overturned. As used herein, the backsplash 16 can be an extension of the back wall 11c or can be a separate element fastened to the apparatus at a time of construction, and the securing unit can include any number of known safety tethers commonly available.

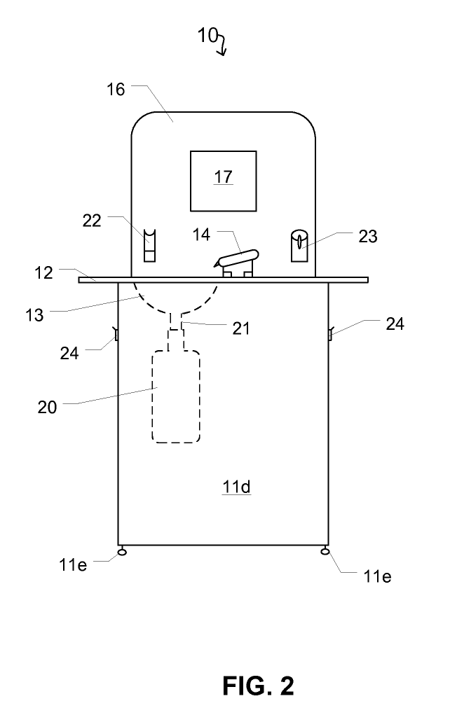

As shown in FIG. 2, the sink 13 can be removably connected to a reservoir container 20 via a drainage conduit 21. In one preferred embodiment, reservoir container 20 can include a plastic bottle having a conventional screw top which can be securely fastened to the bottom end of the drainage conduit. Such a feature allows the drainage reservoir to be quickly and easily removed and cleaned after each use. Additionally, FIG. 2 illustrates several optional features which can be added to the apparatus at the time of construction or as aftermarket options, including: cup dispenser 22 a toothpaste dispenser 23 and a towel holder 24.

As described herein, one or more elements of the portable brushing station 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the lower cabinet area 11, the countertop 12, the sink 13, and/or backsplash 16, for example, may be formed together as one continuous element, either through manufacturing processes, such as welding, casting, or molding, or through the use of a singular piece of material milled or machined with the aforementioned components forming identifiable sections thereof. Accordingly, in one preferred embodiment, each above described element of the brushing station 10 can be constructed from injection molded plastic having a height and dimension suitable for use by children of varying sizes and age groups, however other materials such as metal and rigid plastic are also contemplated.

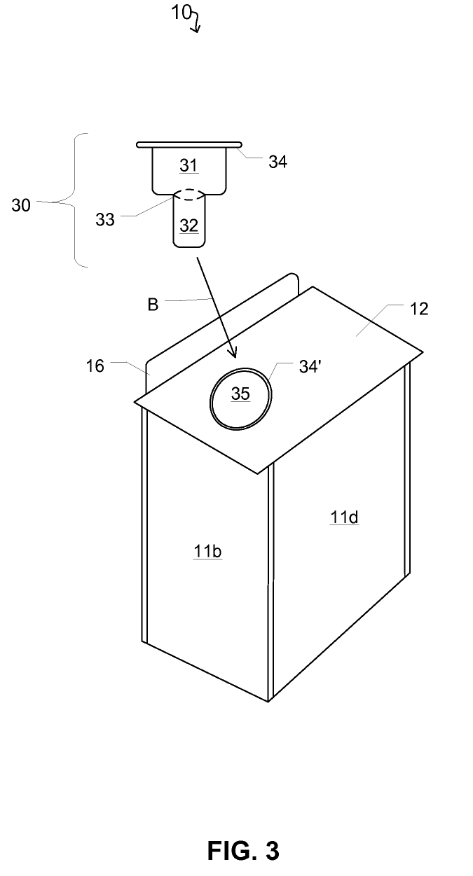

FIG. 3 illustrates an alternate embodiment of a portable brushing station 10 that includes a removable receptacle unit 30 for allowing easy cleaning and maintenance of the apparatus. As shown, receptacle 30 can include a concave sink 31, a drain reservoir 32, an optional drain cover 33 and a magnetized lip 34.

The sink 31 can include a concave shape having an opening along a bottom end that terminates into the drain reservoir 32. The optional drain cover 33 can be removable in nature and configured to snap or screw into the bottom end of the sink 31, just above the drain 32 in order to allow only water to pass into the drain while in use.

As further illustrated, the receptacle unit 30 can be removably inserted into an opening 35 (see arrow B) of the countertop which can include a second magnetized lip 34′ having a polarity opposite to that of the magnetized lip 34 of the receptacle. To this end, when the receptacle 30 is positioned within the opening 35, the sink can be securely connected to the countertop 12, via the magnetic elements, with the drain reservoir located in the interior of the cabinet.

By including such a feature, it now becomes possible to quickly and efficiently clean both the sink and drain area by simply lifting the one piece unit 30 from the apparatus 10 and placing it into a dishwasher or other such device. Such a feature eliminates the need for a user to have to go under the counter, unscrew the reservoir from the sink, clean both the sink and reservoir separately, then repeat the process in order to reattach the elements for their next use.

Although described above as using magnetic elements, other securing devices such as VELCRO and/or compression fittings can also be utilized.

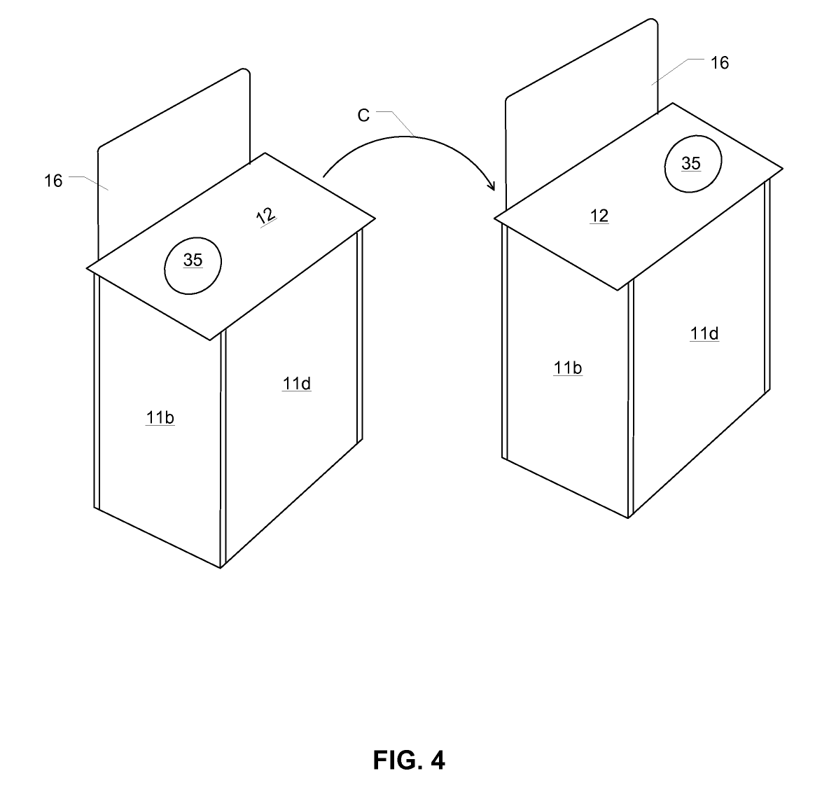

FIG. 4 illustrates an alternative embodiment of a portable brushing station 10 wherein the countertop 12 is reversible. As shown, countertop 12 can be reversible in nature such that a user can install the countertop having the sink opening 35 on either the left side or on the right side by simply overturning the countertop 12 (see arrow C) and securing the bottom side to the cabinet base during the home construction of the unit. Accordingly, the inventive concepts disclosed herein can be enjoyed equally by children that are either right handed or left handed without increasing the cost of construction by having to provide additional materials.

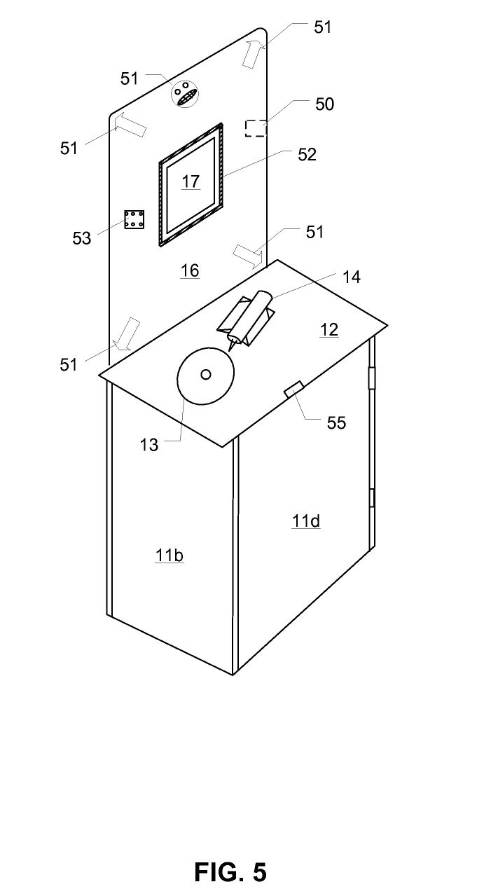

FIG. 5 illustrates another alternate embodiment of a portable brushing station that further includes a plurality of entertainment and instructional aids. As shown, the brushing station 10 can include a control unit 50, instructional aids 51, a display timer 52 and a speaker 53.

The instructional aids 51 can be utilized to instruct a child as to what area of their mouth they should be brushing at any given time. As such, the aids can take any number of different shapes and colors such as, for example, an arrow, a face, and/or teeth, as shown in FIG. 5. Additionally, each instructional aid can further include an imbedded LED or other commonly known illumination device capable of allowing the aid 51 to light up at a predetermined time as will be explained below.

The display timer 52 can act to keep a child engaged with the apparatus in order to ensure that they brush their teeth for a minimum period of time. To this end, timer 52 can include a plurality of LED elements arranged around the mirror 17, for example, which can begin in a fully illuminated state and tick down to zero as time progresses. Alternatively, the timer can include a conventional digital timer (not shown)configured to display a count down of numbers ranging from a predetermined start time, such as two minutes, for example to zero.

Moreover, the brushing station 10 can further include an optional speaker 53 configured to provide an audible entertainment and/or instructional element to the apparatus. To this end, speaker 53 can project any number of things ranging from music to instructions for the child using the apparatus.

The control unit 50 can act to control the operations of the above described elements. To this end, the control unit can include, among other known elements, a processor, a memory and an input/output device 55 such as a switch or lever, for example. In one preferred embodiment, the control unit 50 can be operated via a direct current power source and can include functionality to operate each of the instructional aids, speaker and display device in a precise manner in order to facilitate a child using the brushing station to establish good dental hygiene.

For example, in one embodiment, the control unit 50 can instruct the timer 52 to begin a countdown from two minutes in response to an input from the switch 55 (such as a child pressing an “on” button, for example). Upon beginning the countdown, the controller can signal the display timer 52 to begin a countdown while simultaneously signaling the instructional aids 51 to begin operating for ten seconds each beginning at the upper left corner of the backsplash and making two complete revolutions. In this way, the device would be capable of instructing a child to brush each tooth, front and back, (hence the two revolutions) for a total period of two minutes which is the minimum time recommended by the American Dental Association. As control units for the operation of lights and speakers are extremely well known in the art, no further description will be provided.

With regards to a further description of the manner of usage and operation of the instant invention, the same should be apparent from the above disclosure, and accordingly no further discussion relative to the manner of usage and operation of the instant invention shall be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A portable brushing station, comprising:
a cabinet assembly including a bottom wall having spaced side walls, a back wall and a front wall extending upward therefrom, said front wall having a door configured to allow access to an interior of the cabinet;
a countertop positioned parallel to the bottom wall and having an orthogonal relationship with each of said side, back and front walls;
a concave sink directed downwardly from the countertop, said sink including a drainage conduit;
a portable reservoir container removably connected to the drainage conduit, said reservoir being configured to collect and retain a liquid;
a portable gravity fed water supply container configured to provide fresh water to the sink;
a stand configured to securely and removably position the portable water supply container adjacent to the sink; and
a backboard extending upward from the back wall and having an orthogonal relationship with the countertop, said backboard including a reflective portion and a securing means for securely positioning the brushing station to a fixed location.

2. The brushing station of claim 1, wherein each of said reservoir and water supply unit include a molded plastic bottle configured to be quickly and easily removed and cleaned.

3. The brushing station of claim 1, wherein said concave sink is removably attached to the countertop.

4. The brushing station of claim 3, wherein said sink, and reservoir include a unitary construction so as to form a single element.

5. The brushing station of claim 4, wherein the sink further includes a removable drain cover configured to prevent solid objects from entering the portable reservoir.

6. The brushing station of claim 5, further comprising a connection unit configured to removably secure the sink to the countertop.

7. The brushing station of claim 6, wherein the connection unit includes at least one magnetic element.

8. The brushing station of claim 1, further comprising an instructional unit configured to instruct a user to brush teeth.

9. The brushing station of claim 8, wherein said instructional unit includes at least one of a display timer, an instructional aid having a lighted element, a speaker and a user interface.

10. The brushing station of claim 8, wherein said instructional unit comprises a display timer, a plurality of instructional aids, a speaker and a user interface.

11. The brushing station of claim 1, further including at least one of a toothpaste dispenser, a cup holder and a towel holder.

12. A portable brushing station, comprising:
a cabinet assembly including a bottom wall having spaced side walls, a back wall and a front wall extending upward therefrom, said front wall having a door configured to allow access to an interior of the cabinet;
a countertop positioned parallel to the bottom wall and having an orthogonal relationship with each of said side, back and front walls, said countertop including an opening positioned along one side thereof;
a portable sink and reservoir unit configured to receive and store a liquid,
wherein a portion of said sink and reservoir unit is configured to be placed within said opening;
a portable gravity fed water supply container configured to provide fresh water to the sink;
a stand configured to securely and removably position the portable water supply container adjacent to the opening; and
a backboard extending upward from the back wall and having an orthogonal relationship with said countertop, said backboard including a reflective portion and a securing means for securely positioning the brushing station to a fixed location.

13. The brushing station of claim 12, wherein the countertop is reversible.

14. The brushing station of claim 12, wherein the sink and reservoir unit includes a removable drain cover configured to prevent solid objects from entering the reservoir.

15. The brushing station of claim 12, further comprising a connection unit configured to removably secure the sink and reservoir unit to the countertop.

16. The brushing station of claim 15, wherein the connection unit includes at least one magnetic element.

17. The brushing station of claim 12, further comprising an instructional unit configured to instruct a user to brush teeth.

18. The brushing station of claim 17, wherein said instructional unit includes at least one of a display timer, an instructional aid having a lighted element, a speaker and a user interface.

19. The brushing station of claim 17, wherein said instructional unit comprises a display timer, a plurality of instructional aids having at least one lighted element each, a speaker and a user interface.
